(19) United States
(12) Patent Application Publication
(10) Pub. No.: US 2025/0076255 A1
(43) Pub. Date: Mar. 6, 2025

(54) INSERTION AIDING CENTERING DEVICES FOR EDDY CURRENT PROBES

(71) Applicant: Zetec Inc., Snoqualmie, WA (US)

(72) Inventors: Tom O’Dell, Ravensdale, WA (US); Evan Lloyd, Fall City, WA (US); Brooks McKinney, Bellevue, WA (US); Wayne Rector, Bellevue, WA (US); William Frederick Ziegenhagen, Black Diamond, WA (US)

(21) Appl. No.: 18/817,488

(22) Filed: Aug. 28, 2024

Related U.S. Application Data
(60) Provisional application No. 63/579,713, filed on Aug. 30, 2023.

(51) Int. Cl. G01N 27/9093

(52) U.S. Cl. CPC G01N 27/9093

(57) ABSTRACT

A centering assembly for an eddy current probe having a shaft includes a body portion configured to couple to the shaft and a plurality of wheels rotatably coupled to the body portion. At least a portion of each of the plurality of wheels projects beyond an outer surface of the body portion to engage a conduit under test.

### CROSS-REFERENCE TO RELATED APPLICATION

This application claims priority under 35 U.S.C. § 119, based on U.S. Provisional Patent Application No. 63/579,713 filed Aug. 30, 2023, titled “Insertion Aiding Centering Devices for Eddy Current Probes,” the disclosure of which is hereby incorporated by reference.

### BACKGROUND

Routine monitoring of the condition of industrial conduit or tubing is critical to safe and efficient operation of many systems. Such conduit or tube inspection is generally conducted with cylindrically shaped eddy current probes that are inserted into a conduit under test. The eddy current probe travels through the conduit/tubes and emits eddy currents onto surfaces of the tubes. The tubes are attached to cabling while monitoring equipment records the eddy current response as the probe travels through the tubes.

Eddy current probes operate by using coils alternating an electromagnet field onto a conduit as it travels within the conduit and receiving electromagnetic returns via the conduit. The electromagnetic field produces eddy currents in the tubes, which can be measured either by a change in impedance of the excitation coil or by separate coils, hall-effect sensors or magneto-resistive sensors. In interacting with the conduit structure, the probe is able to locate defects by recognizing anomalies, such as disbonds, bubbles, cracks, corrosion, delaminations, thickness variation, and the like.

Typical eddy current probes for non-destructive testing of heat exchanger tubing and the like are composed of a probe head supporting a plurality of sensing coils, a flexible plastic conduit with wiring and a connector providing a removable connection to testing equipment. Probe heads often incorporate features to center the coil assembly in the center of the tube under inspection. This centering reduces “lift-off” in which the probe moves away from the tube wall and such centering is important for maintaining good signal quality.

This centering function has been done in the past by machined plastic, metallic, or ceramic parts that incorporate a plurality of flexible fingers extending from the probe that apply an equal circumferential force to the inner wall of the tubing under inspection. Because these parts bear against the tube wall, they are subject to wear as the sensor is moved in and out of hundreds of tubes which may involve thousands of feet of sliding friction wear. These effects can drive the sensor out of its centered position causing lift-off errors. Additionally, if the wear on the feet is even but substantial, the feet may no longer press against the tube wall and the sensor may become loose within the tube, which causes erratic movement and creates data quality issues. Accordingly, after a period of use the probe becomes unreliable and therefore unusable due to the abraded centering feet.

Additionally, known friction-based centering mechanisms may make it difficult to insert the probe into conduit under test, particularly where the conduit is long or includes tight or convoluted turns, such as spiral or helical tubing. This is caused by the increased friction forces due to the capstan equation (T_{load}=T_{hold} e^{μØ}), where the friction in the tube is exponentially increased due to the angular degrees of bend (Ø) and the coefficient of friction (μ). Given a reasonable coefficient of friction 0.4μ for nylon on steel conduit, only four complete 360° turns in the conduit would result in a T_{load} factor of 58,070, rendering moving a probe through the conduit nearly impossible.

### BRIEF DESCRIPTION OF THE DRAWINGS

FIG. 1 is a perspective view of an eddy current probe in a partially assembly configuration consistent with embodiments described herein;

FIGS. 2A-2C illustrate side, end, and isometric views, respectively, of an exemplary probe centering assembly consistent with embodiments described herein;

FIG. 2D is a partially exploded isometric view of the probe centering assembly of FIG. 2C;

FIGS. 3A and 3B illustrate end and isometric views, respectively, of an exemplary centering bead consistent with embodiments described herein.

FIG. 3C is a side view of the centering bead of FIGS. 3A and 3B inserted within a conduit under test;

FIG. 4 is a front view of an exemplary bead roller consistent with embodiments described herein;

FIGS. 5A and 5B illustrate end and isometric views, respectively, of another exemplary centering bead consistent with embodiments described herein; and

FIGS. 6A and 6B illustrate end and isometric views, respectively, of yet another exemplary centering bead consistent with embodiments described herein.

### DESCRIPTION OF THE PREFERRED EMBODIMENTS OF THE INVENTION

The following detailed description refers to the accompanying drawings. The same reference numbers in different drawings may identify the same or similar elements. Also, the following detailed description does not limit the invention.

Implementations described herein relate to non-destructive testing devices that include one or more testing coils for introducing an electromagnetic field into a tubular conduit under test. The non-destructive testing devices include a probe body coupled to a shaft via one or more centering assemblies (referred to as centering feet or centering beads). The centering assemblies include one or more resilient portions configured to be radially biased away from the shaft. The resilient portions are configured to engage the internal surface of the conduit under test to keep the probe body centered within the conduit as the probe body travels within the conduit. In addition, the shaft to which the probe body is coupled may include one or more centering beads positioned thereon for maintaining the shaft in a centered position within the conduit under test.

Consistent with implementations described herein, the one or more centering assemblies and/or centering beads may include roller elements for decreasing the friction between the centering assemblies and/or beads and the conduit under test. In particular, exemplary roller elements include a plurality of wheel and axle assemblies positioned within the outer circumferences of the centering assemblies and/or centering beads in the manner described below.

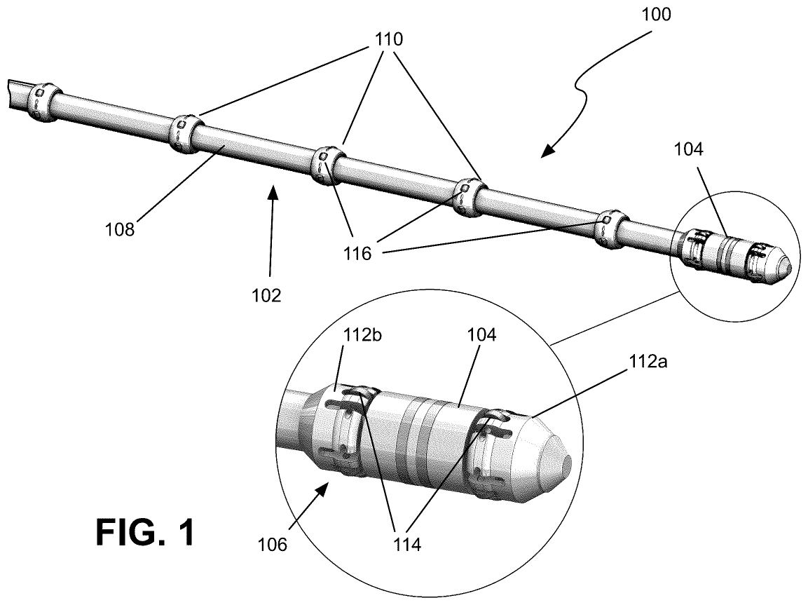

FIG. 1 is an isometric view of an eddy current probe 100 and delivery tubing 102 consistent with implementations described herein. As shown, eddy current probe 100 includes a probe body 104 and a probe-centering apparatus 106. Delivery tubing 102 (also referred to as delivery shaft, or delivery conduit) includes a tubular body 108 and a number of centering beads 110 positioned on tubular body 108.

Probe body 104 includes at least one eddy current coil that projects and detects an alternating electromagnetic field within a tube under test. Consistent with implementations described herein, probe centering apparatus 106 includes a pair of centering assemblies 112 for centering probe body 104 within a tube under test (not shown in FIG. 1).

As shown in FIG. 1, probe body 104 is coupled to delivery tubing 102 between a forward centering assembly 112a and a rearward centering assembly 112b (referred to collectively as centering assemblies 112 and individually as centering assembly 112). As described herein, centering assemblies 112 are configured to maintain probe body 104 centered within a tube under test during testing.

As further shown in FIG. 1 and consistent with implementations described herein, centering assemblies 112 include a plurality of probe centering roller assemblies 114 rotationally coupled to an outer circumference thereof. As described in more detail below, each probe centering roller assembly 114 includes at wheel and axle aligned with the axial direction of probe body. Similarly, centering beads 110 include a plurality of centering bead roller assemblies 116 rotationally coupled to an outer circumference of each centering bead 110. As with probe-centering roller assemblies 114, each centering bead roller assembly 116 includes a wheel and axle aligned with the axial direction of its respective centering bead 110.

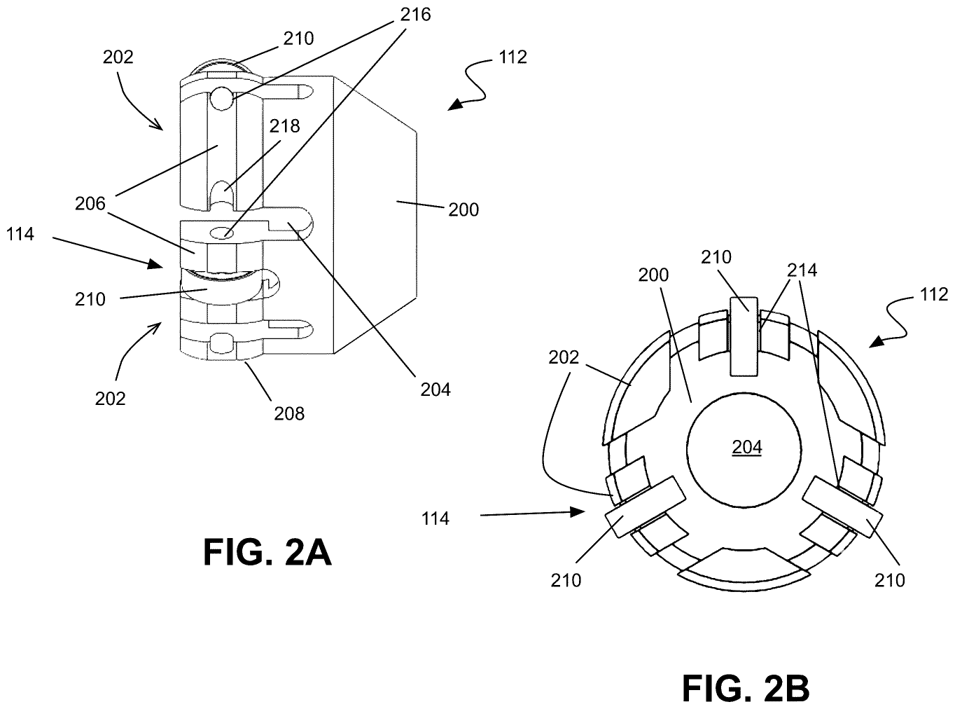

FIGS. 2A-2C illustrate side, end, and isometric views, respectively, of an exemplary probe centering assembly 112 consistent with embodiments described herein. FIG. 2D is a partially exploded isometric view of a probe centering assembly 112. As shown, each probe centering assembly 112 includes a tubular or frustoconical base portion 200, from which a plurality of resilient cantilevered legs 202 project radially and distally outwardly therefrom and are coaxially spaced apart from base portion 200. As shown in FIG. 2B, tubular base portion 200 and resilient cantilevered legs 202 form a central aperture 204 configured to engage probe body 104 and/or delivery tubing 102. Consistent with implementations described herein, base portion 200 and resilient cantilevered legs 202 are manufactured (e.g., injection molded, 3D printed, etc.) from a single material.

Each cantilevered leg 202 includes a centering foot 206 at its distal end that includes a curvilinear outer surface 208, at least a portion of which is configured to extend beyond a body of an eddy current probe 100 to which centering assembly 112 is attached. Centering feet 206 on respective legs 202 extend outwardly, such that the circumferentially spaced centering feet 206, and not the eddy current probe body 104, slidably engage the tube under test through which the probe 100 travels. The resilient nature of cantilevered legs 202 allows each leg to flex as necessary to maintain the probe centered within the tube when the legs 202 engage the inner surface of the tube. In one implementation, each centering assembly 112 includes six cantilevered legs 202, although any suitable number of legs 202 may be used.

Consistent with implementations described herein, probe centering assembly 112 further includes one or more probe centering roller assemblies 114 for reducing a friction between eddy current probe 100 and the conduit or tube into which it is inserted. As shown in FIGS. 1 and 2A-2C, probe centering assemblies 112 includes probe centering roller assemblies 114 on a plurality of cantilevered legs 202. In one exemplary implementation, probe centering roller assemblies 114 are provided on alternate ones of the plurality of cantilevered legs 202, such as on three of the six cantilevered legs 202. However, more or fewer probe centering roller assemblies 114 (e.g., two, four, etc.) may be provided. In other implementations, probe centering roller assemblies 114 may be provided on each of cantilevered legs 202.

In one implementation, each probe centering roller assembly 114 comprises a roller wheel 210 and an axle 212. As shown in FIGS. 2B-2D, to accommodate installation of wheel 210 and an axle 212 in each respective cantilevered leg 202, an axial slot 214 and axle apertures 216 are formed in each respective centering foot 206. In particular, axial slot 214 may be formed at a distal end of centering foot 206 and may be sized to accommodate a width and outside diameter of wheel 210. Axle apertures 216 may be formed transversely through each respective centering foot 206 on opposite sides of axial slot 214 and sized to accommodate receipt of axle 212 therethrough. To accommodate efficient assembly of probe centering roller assemblies 114 and depending on a size and scale of probe centering assembly 112, axle access grooves 218 may be formed in adjacent centering feet 206 in alignment with axle apertures 216 to allow axles 212 to be inserted into axle apertures 216 without difficulty.

As shown in FIGS. 2A-2D, each wheel 210 may have an outside diameter sufficient to project beyond an outside surface of centering foot 206 when installed therein. In this manner, the rotating outside surface of wheels 210 engage the inside surface of the conduit under test rather than the outside surface of the centering foot 206 into which it is installed.

In one implementation, the outside diameter of axle 212 may be significantly smaller than the outside diameter of wheel 210, so as to reduce the secondary friction caused by the mechanical relationship of the axle 212 and wheel 210. For example, when axle 212 is approximately one third of the diameter of wheel 210, a resulting secondary friction factor is reduced to only 33% of the total friction of the system. Such an arrangement ensures that the wheel 210 is more likely to roll than to slide along the tube wall and thus requires lower forces to create probe movement.

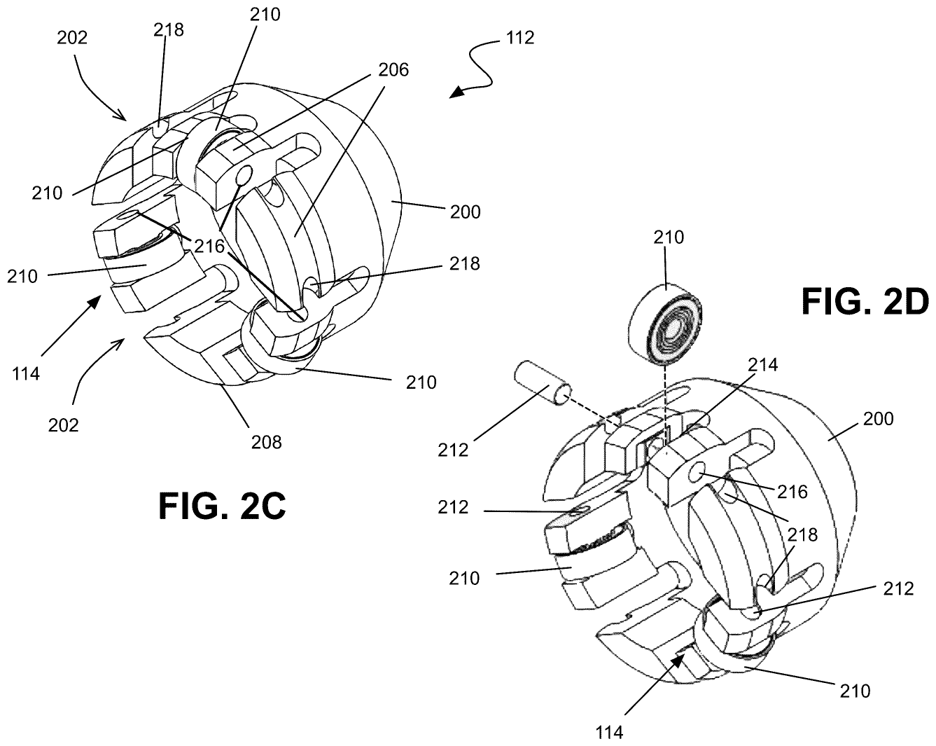

FIGS. 3A and 3B illustrate end and isometric views, respectively, of an exemplary centering bead 110 consistent with embodiments described herein. FIG. 3C is a side view of the centering bead 110 of FIGS. 3A and 3B inserted within a conduit under test 300. As shown, probe centering bead 110 includes a tubular body 302 having a central aperture 304 extending therethrough and a curvilinear outer surface 306. As shown in FIG. 3C, central aperture 304 is sized to engage delivery shaft body 108.

As shown in FIG. 3B, curvilinear outer surface 306 may include a maximum outside diameter at its axial midpoint 307 and minimum outside diameters at its proximal and distal ends 308 and 309, respectively. In implementations without centering bead roller assemblies 116, or in which centering bead roller assemblies 116 have worn down, such a configuration reduces the surface area with which delivery tubing 102 contacts conduit under test 300.

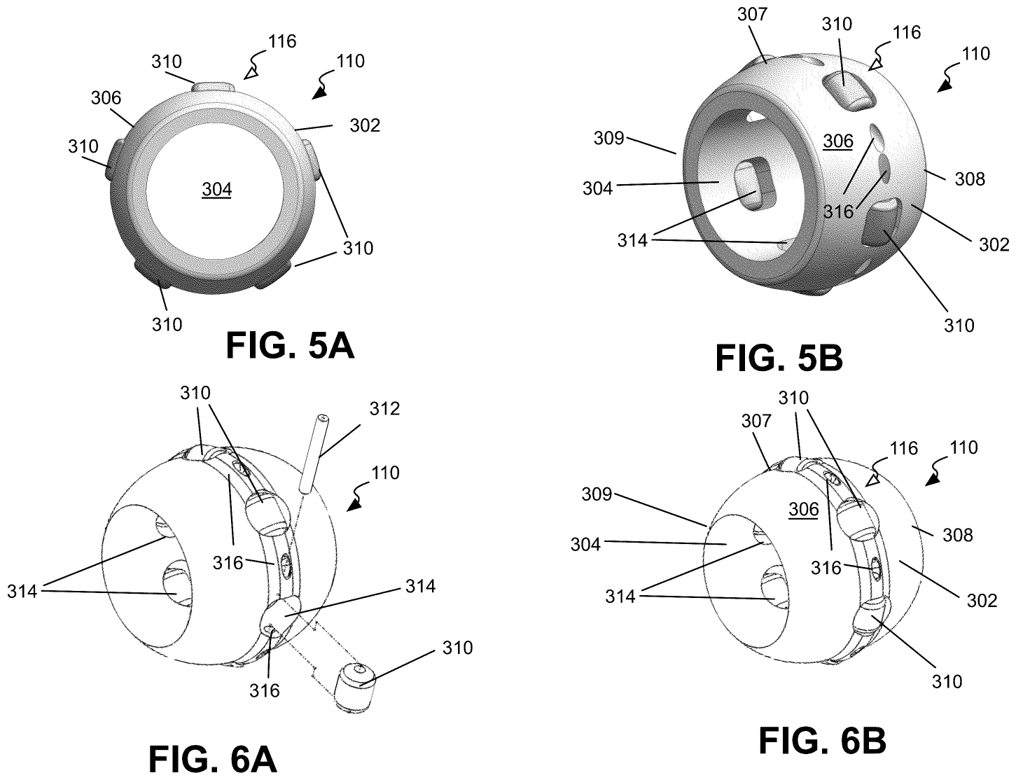

Consistent with implementations described herein, centering bead roller assemblies 116 may include a plurality of bead rollers 310 and roller axles 312 (shown in FIG. 6A). To accommodate installation of bead rollers 310 and roller axles 312, a plurality of equidistantly spaced roller apertures 314 are formed in tubular body 302 at its axial midpoint 307. Axle apertures 316 are formed transversely through tubular body 302 on opposite sides of roller apertures 314 and sized to accommodate receipt of roller axles 312 therethrough.

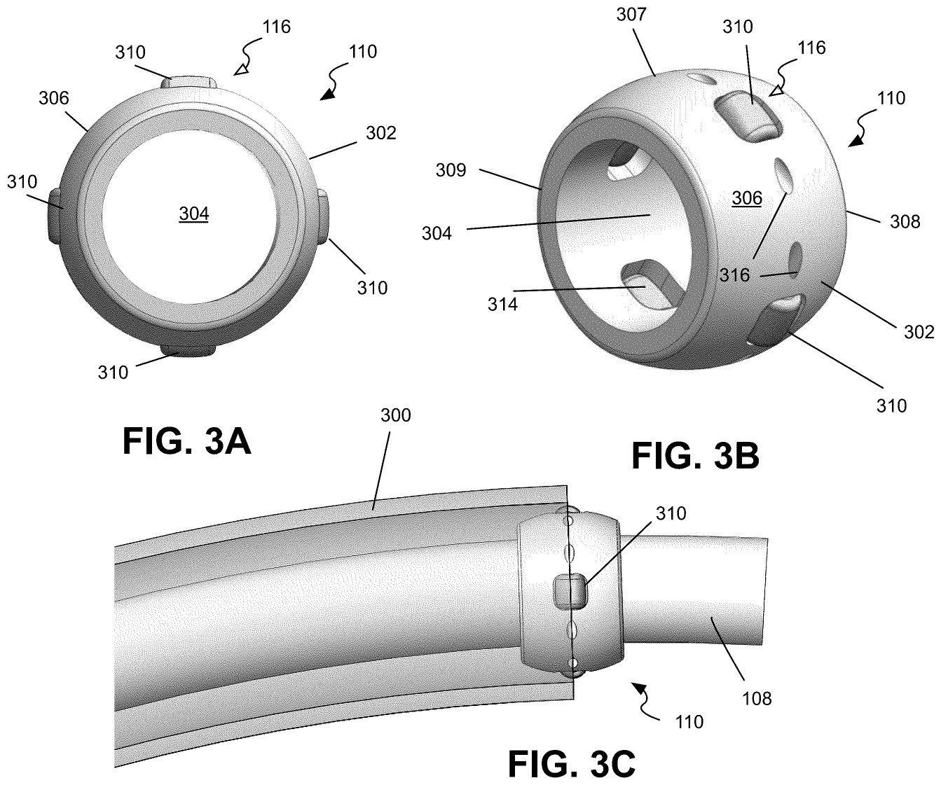

Consistent with implementations described herein, each bead roller 310 may have a configuration designed to provide the least amount of friction for the particular application of rolling inside a cylindrical tube. FIG. 4 is a front view of an exemplary bead roller 310 indicating exemplary aspects. As shown, bead roller 310 includes a generally curvilinear outer surface having a face contour 402, an outside diameter 404, a width 406, and a central aperture diameter 408. In one implementation, face contour 402 may have a radius of curvature that corresponds to an inside diameter of the conduit under test. In other implementations, face contour 402 may have a radius of curvature suitable for range of possible applications, such as a radius of curvature of approximately 0.5″. Furthermore, in one implementation, outside diameter 404 is approximately three times the width of central aperture diameter 408. As described above, such a relationship minimizes the impact of secondary friction between bead roller 310 and roller axle 312.

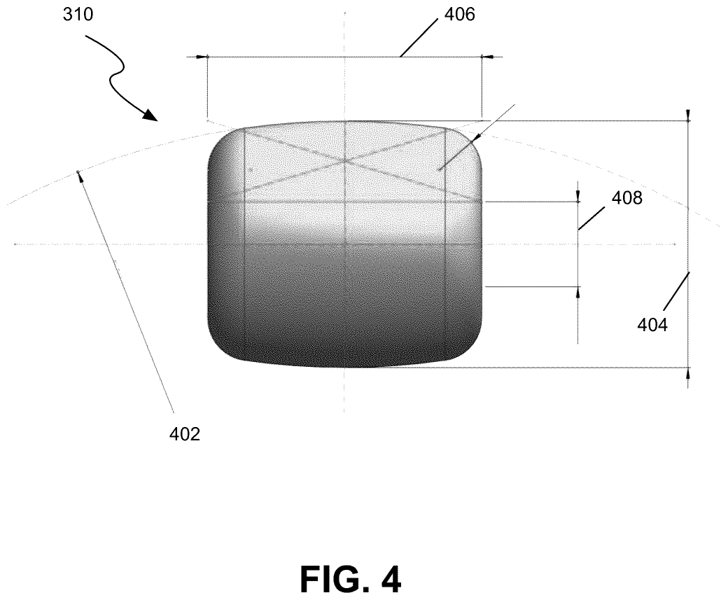

Centering bead roller assemblies 116 shown in FIGS. 3A-3C include four equidistantly spaced bead rollers 310, however other suitable numbers of bead rollers 310 may be used. For example, FIGS. 5A and 5B depict end and isometric views, respectively, of a centering bead 110 having five equidistantly spaced bead rollers 310 and FIGS. 6A and 6B depict isometric and partially exploded isometric views, respectively, of a centering bead 110 having six equidistantly spaced bead rollers 310.

The foregoing description of exemplary implementations provides illustration and description but is not intended to be exhaustive or to limit the embodiments described herein to the precise form disclosed. Modifications and variations are possible in light of the above teachings or may be acquired from practice of the embodiments. For example, variations to the numbers or dimensions of wheels 210 or bead rollers 310 may be made without departing from the improvements described herein.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above-mentioned description is to be considered exemplary, rather than limiting, and the true scope of the invention is that defined in the following claims.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

What is claimed is:

1. A centering assembly for an eddy current probe having a shaft, comprising:
a body portion configured to couple to the shaft; and
a plurality of wheels rotatably coupled to the body portion,
wherein at least a portion of each of the plurality of wheels projects beyond an outer surface of the body portion.

2. The centering assembly of claim 1,
wherein the body portion comprises:
a tubular or frustoconical base, and
a plurality of resilient cantilevered legs that project radially and distally outwardly from the tubular or frustoconical base,
wherein the plurality of wheels are positioned within at least two of the plurality of resilient cantilevered legs.

3. The centering assembly of claim 2, wherein the plurality of resilient cantilevered legs are circumferentially spaced from each other, and
wherein the plurality of wheels are positioned alternately within axial slots in every other one of the plurality of resilient cantilevered legs.

4. The centering assembly of claim 3, wherein the plurality of resilient cantilevered legs comprise six circumferentially spaced resilient cantilevered legs and wherein the plurality of wheels comprise three wheels.

5. The centering assembly of claim 3, wherein the plurality of wheels are provided on each of the plurality of resilient cantilevered legs.

6. The centering assembly of claim 3, wherein each of the every other one of the plurality of resilient cantilevered legs that include axial slots further include axle apertures formed transversely through the axial slots, and
wherein each of the plurality of wheels are coupled to the body portion via respective axles received within the axial apertures.

7. The centering assembly of claim 6, wherein a remaining plurality of resilient cantilevered legs that do not include wheels comprise axle access grooves formed in an outer surface thereof and aligned with the axle apertures within the alternating resilient cantilevered legs.

8. The centering assembly of claim 6, wherein an outside diameter of each of the plurality of wheels is significantly larger than an outside diameter of each of the axles.

9. The centering assembly of claim 8, wherein an outside diameter of each of the plurality of wheels is approximately three times larger than an outside diameter of each of the axles.

10. The centering assembly of claim 1, wherein the body portion comprises a centering bead coupled to the shaft, and
wherein the plurality of wheels comprise a plurality of bead rollers rotatably coupled to the centering bead.

11. The centering assembly of claim 10, wherein the centering bead comprises a curvilinear outer surface having a maximum outside diameter at its axial midpoint,
wherein the centering bead comprises a plurality of roller apertures formed at the axial midpoint for receiving the respective plurality of bead rollers, and
wherein the plurality of bead rollers are rotatably coupled within the plurality of roller apertures.

12. The centering assembly of claim 11, wherein the plurality of bead rollers are equidistantly spaced about the axial midpoint of the curvilinear outer surface.

13. The centering assembly of claim 12, wherein the plurality of bead rollers comprise between four and six bead rollers.

14. The centering assembly of claim 11, wherein each of the plurality of bead rollers are coupled to the centering bead via respective axles received within axle apertures formed transversely through the roller apertures.

15. The centering assembly of claim 14, wherein an outside diameter of each of the plurality of bead rollers is significantly larger than an outside diameter of each of the axles.

16. The centering assembly of claim 15, wherein an outside diameter of each of the plurality of bead rollers is approximately three times larger than an outside diameter of each of the axles.

17. The centering assembly of claim 10, wherein each of the bead rollers comprises a curvilinear outer surface.

18. The centering assembly of claim 17, wherein the curvilinear outer surface comprises a radius of curvature or approximately 0.5 inches.

19. The centering assembly of claim 18, wherein the curvilinear outer surface comprises a radius of curvature substantially identical to a radius of curvature of a tube or shaft into which the eddy current probe is inserted.

20. A centering assembly for an eddy current probe and delivery tubing, comprising:
at least one at probe centering assembly provided adjacent the eddy current probe; and
at least one centering bead coupled to the delivery tubing,
wherein the at least one probe centering assembly comprises:
a tubular or frustoconical base;
a plurality of resilient cantilevered legs that project radially and distally outwardly from the tubular or frustoconical base; and
a plurality of probe centering wheels rotatably coupled to the tubular or frustoconical base and positioned within at least two of the plurality of resilient cantilevered legs,
wherein at least a portion of each of the plurality of wheels projects beyond an outer surface of the body portion; and
wherein the at least one centering bead comprises:
a curvilinear outer surface having a maximum outside diameter at its axial midpoint,
a plurality of roller apertures formed at the axial midpoint for receiving a respective plurality of bead rollers, and
wherein the plurality of bead rollers are rotatably coupled within the plurality of roller apertures.
